(19) United States
(12) Patent Application Publication
(10) Pub. No.: US 2016/0222775 A1
(43) Pub. Date: Aug. 4, 2016

(54) UNIFIED CONTROL SYSTEM FOR DRILLING RIGS

(71) Applicant: Schlumberger Technology Corporation, Sugar Land, TX (US)

(72) Inventors: Gokturk Tunc, Houston, TX (US); Shunfeng Zheng, Katy, TX (US); Mario Chiock, Richmond, TX (US); Vishwanathan Parmeshwar, Houston, TX (US); Malcolm Keenleyside, London (GB)

(21) Appl. No.: 14/788,038

(22) Filed: Jun. 30, 2015

Related U.S. Application Data
(60) Provisional application No. 62/109,923, filed on Jan. 30, 2015.

(51) Int. Cl. E21B 44/00; G05B 15/02

(52) U.S. Cl. CPC E21B 44/005; G05B 15/02

(57) ABSTRACT

Systems and methods for a drilling rig. The method includes receiving, at a rig controller, data from a plurality of rig subsystems, and determining, at the rig controller, a first command based at least partially on the data from the plurality of rig subsystems. The first command is related to an operating parameter of a first device of a first one of the plurality of rig subsystems. The method also includes transmitting the first command to a first subsystem controller of the first one of the plurality of rig subsystems. The first subsystem controller is configured to control the first device and implement the command.

### CROSS-REFERENCE TO RELATED APPLICATIONS

This application claims priority to U.S. Provisional Patent Application Ser. No. 62/109,923, which was filed Jan. 30, 2015, and is incorporated herein by reference in its entirety.

### BACKGROUND

This disclosure relates to drilling rigs and, more particularly, to a unified control system for drilling rigs.

A drilling rig may include a number of unintegrated systems for performing various operations of the drilling rig. For example, drilling operations, pumping operations, hoisting and rotating operations, and other operations may be performed using different discrete systems. Each discrete system may include different components, such as controllers, for implementing the operations. The components of such systems may be provided by different entities (e.g., companies, operators, etc.). Moreover, operations performed on the drilling rig may be performed by different entities, and each entity may have varying degrees of communication with other entities or systems present at the drilling rig (i.e., an entity might not have access to another entities' system, or an entity might not have the ability to control another entities' systems). Additionally, the control of a drilling rig could involve multiple entities and the ability to control drilling rig systems might be limited to onsite access at the drilling rig.

### SUMMARY

Embodiments of the disclosure may provide a method for a drilling rig. The method includes receiving, at a rig controller, data from a plurality of rig subsystems, and determining, at the rig controller, a first command based at least partially on the data from the plurality of rig subsystems. The first command is related to an operating parameter of a first device of a first one of the plurality of rig subsystems. The method also includes transmitting the first command to a first subsystem controller of the first one of the plurality of rig subsystems. The first subsystem controller is configured to control the first device and implement the command.

Embodiments of the disclosure may also provide a method for a drilling rig. The method includes receiving, at a control system, sensor data from a plurality of subsystems, each of the plurality of subsystems including a subsystem controller. The method also includes determining, at the control system, a command for a device of the drilling rig based on the sensor data from at least two of the plurality of subsystems. The device is controlled by the subsystem controller of one of the plurality of subsystems. The method also includes transmitting data representing the command to the subsystem controller of the one of the plurality of subsystems. The data is configured to cause the subsystem controller of the one of the plurality of subsystems to implement the parameter adjustment

Embodiments of the disclosure may further provide a system for a drilling rig. The system includes a computing resource environment located at a drilling rig, the computing resource environment including a control device. The system also includes a human-machine interface for receiving a first command from a user. The control device is configured to receive sensor data from a plurality of subsystems of the drilling rig and to provide control commands to a plurality of subsystems based upon the sensor data and the first command.

The foregoing summary is provided to introduce a subset of the features discussed in greater detail below. Thus, this summary should not be considered exhaustive or limiting on the disclosed embodiments or the appended claims.

### BRIEF DESCRIPTION OF THE DRAWINGS

Various aspects of this disclosure may be better understood upon reading the following detailed description and upon reference to the drawings in which:

FIG. 1 is a schematic diagram illustrating a drilling rig and an example unified control system in accordance with an embodiment of the disclosure;

FIG. 2 is a block diagram illustrating an example unified control system for a drilling rig in accordance with an embodiment of the disclosure;

FIGS. 3A and 3B are block diagrams providing example control processes via the unified control system of FIG. 2 in accordance with an embodiment of the disclosure;

FIG. 4 is a block diagram depicting the addition of an example offsite user device to the unified control system of FIG. 2 in accordance with an embodiment of the disclosure;

FIG. 5 is a block diagram depicting example networks of the unified control system of FIG. 2 in accordance with an embodiment of the disclosure;

FIG. 6 is a block diagram of an example control process via an example unified control system for a drilling rig in accordance with an embodiment of the disclosure;

FIG. 7 is a diagram of rig crews of a non-unified control system and a unified control system in accordance with an embodiment of the disclosure; and

FIG. 8 illustrates a schematic view of a computing system in accordance with an embodiment of the disclosure.

### DETAILED DESCRIPTION

Reference will now be made in detail to specific embodiments illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object or step, and, similarly, a second object could be termed a first object or step, without departing from the scope of the present disclosure.

The terminology used in the description of the invention herein is for the purpose of describing particular embodiments only and is not intended to be limiting. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

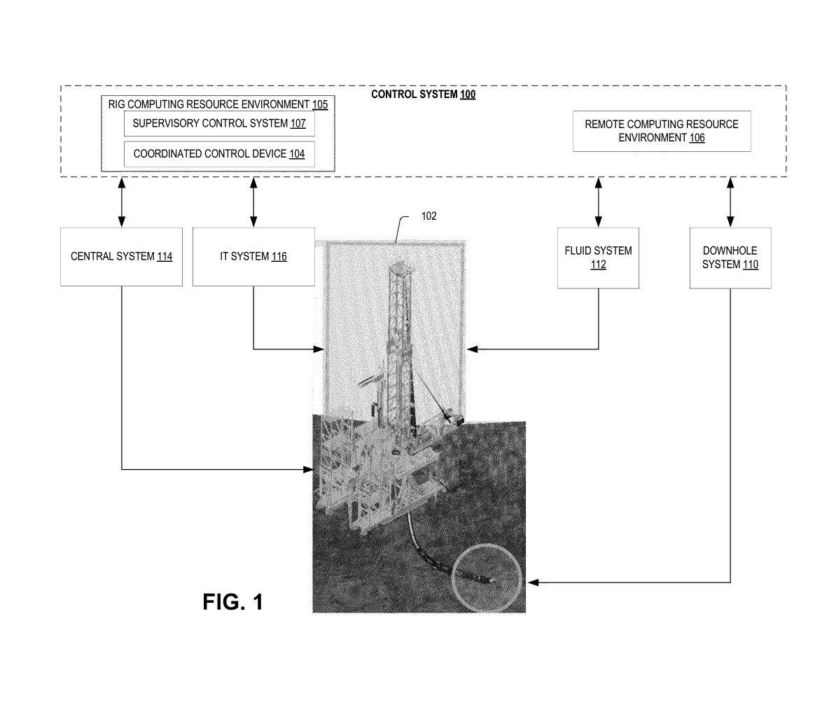

FIG. 1 illustrates a conceptual, schematic view of a control system 100 for a drilling rig 102, according to an embodiment. The control system 100 may include a rig computing resource environment 105, which may be located onsite at the drilling rig 102 and, in some embodiments, may have a coordinated control device 104. The control system 100 may also provide a supervisory control system 107. In some embodiments, the control system 100 may include a remote computing resource environment 106, which may be located offsite from the drilling rig 102.

The remote computing resource environment 106 may include computing resources locating offsite from the drilling rig 102 and accessible over a network. A “cloud” computing environment is one example of a remote computing resource. The cloud computing environment may communicate with the rig computing resource environment 105 via a network connection (e.g., a WAN or LAN connection). In some embodiments, the remote computing resource environment 106 may be at least partially located onsite, e.g., allowing control of various aspects of the drilling rig 102 onsite through the remote computing resource environment 102 (e.g., via mobile devices). Accordingly, “remote” should not be limited to any particular distance away from the drilling rig 102.

Further, the drilling rig 102 may include various systems with different sensors and equipment for performing operations of the drilling rig 102, and may be monitored and controlled via the control system 100, e.g., the rig computing resource environment 105. Additionally, the rig computing resource environment 105 may provide for secured access to rig data to facilitate onsite and offsite user devices monitoring the rig, sending control processes to the rig, and the like.

Various example systems of the drilling rig 102 are depicted in FIG. 1. For example, the drilling rig 102 may include a downhole system 110, a fluid system 112, and a central system 114. In some embodiments, the drilling rig 102 may include an information technology (IT) system 116. The downhole system 110 may include, for example, a bottomhole assembly (BHA), mud motors, sensors, etc. disposed along the drill string, and/or other drilling equipment configured to be deployed into the wellbore. Accordingly, the downhole system 110 may refer to tools disposed in the wellbore, e.g., as part of the drill string used to drill the well.

The fluid system 112 may include, for example, drilling mud, pumps, valves, cement, mud-loading equipment, mud-management equipment, pressure-management equipment, separators, and other fluids equipment. Accordingly, the fluid system 112 may perform fluid operations of the drilling rig 102.

The central system 114 may include a hoisting and rotating platform, top drives, rotary tables, kellys, drawworks, pumps, generators, tubular handling equipment, derricks, masts, substructures, and other suitable equipment. Accordingly, the central system 114 may perform power generation, hoisting, and rotating operations of the drilling rig 102, and serve as a support platform for drilling equipment and staging ground for rig operation, such as connection make up, etc. The IT system 116 may include software, computers, and other IT equipment for implementing IT operations of the drilling rig 102.

The control system 100, e.g., via the coordinated control device 104 of the rig computing resource environment 105, may monitor sensors from multiple systems of the drilling rig 102 and provide control commands to multiple systems of the drilling rig 102, such that sensor data from multiple systems may be used to provide control commands to the different systems of the drilling rig 102. For example, the system 100 may collect temporally and depth aligned surface data and downhole data from the drilling rig 102 and store the collected data for access onsite at the drilling rig 102 or offsite via the rig computing resource environment 105. Thus, the system 100 may provide monitoring capability. Additionally, the control system 100 may include supervisory control via the supervisory control system 107.

In some embodiments, one or more of the downhole system 110, fluid system 112, and/or central system 114 may be manufactured and/or operated by different vendors. In such an embodiment, certain systems may not be capable of unified control (e.g., due to different protocols, restrictions on control permissions, safety concerns for different control systems, etc.). An embodiment of the control system 100 that is unified, may, however, provide control over the drilling rig 102 and its related systems (e.g., the downhole system 110, fluid system 112, and/or central system 114, etc.). Further, the downhole system 110 may include one or a plurality of downhole systems. Likewise, fluid system 112, and central system 114 may contain one or a plurality of fluid systems and central systems, respectively.

In addition, the coordinated control device 104 may interact with the user device(s) (e.g., human-machine interface(s)) 118, 120. For example, the coordinated control device 104 may receive commands from the user devices 118, 120 and may execute the commands using two or more of the rig systems 110, 112, 114, e.g., such that the operation of the two or more rig systems 110, 112, 114 act in concert and/or off-design conditions in the rig systems 110, 112, 114 may be avoided.

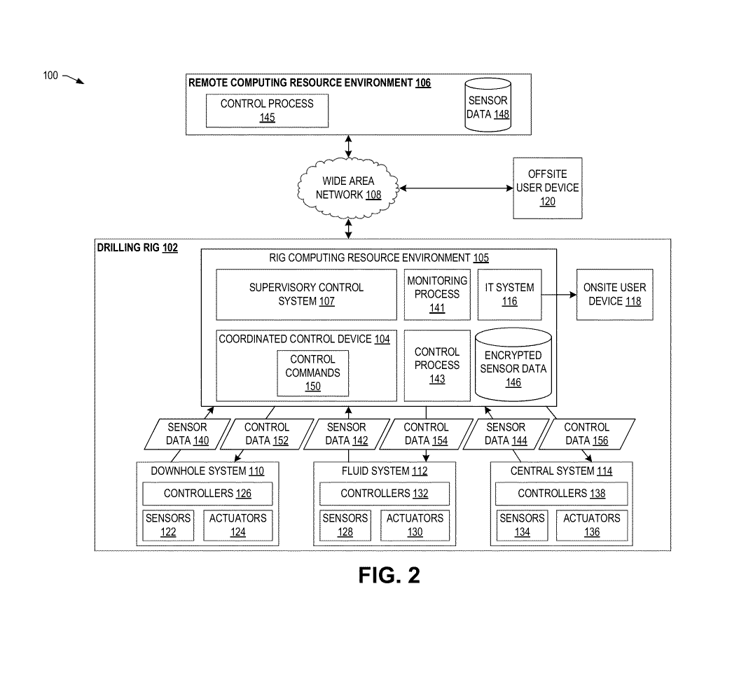

FIG. 2 illustrates a conceptual, schematic view of the control system 100, according to an embodiment. The rig computing resource environment 105 may communicate with offsite devices and systems using a network 108 (e.g., a wide area network (WAN) such as the internet). Further, the rig computing resource environment 105 may communicate with the remote computing resource environment 106 via the network 108. FIG. 2 also depicts the aforementioned example systems of the drilling rig 102, such as the downhole system 110, the fluid system 112, the central system 114, and the IT system 116. In some embodiments, one or more onsite user devices 118 may also be included on the drilling rig 102. The onsite user devices 118 may interact with the IT system 116. The onsite user devices 118 may include any number of user devices, for example, stationary user devices intended to be stationed at the drilling rig 102 and/or portable user devices. In some embodiments, the onsite user devices 118 may include a desktop, a laptop, a smartphone, a personal data assistant (PDA), a tablet component, a wearable computer, or other suitable devices. In some embodiments, the onsite user devices 118 may communicate with the rig computing resource environment 105 of the drilling rig 102, the remote computing resource environment 106, or both.

One or more offsite user devices 120 may also be included in the system 100. The offsite user devices 120 may include a desktop, a laptop, a smartphone, a personal data assistant (PDA), a tablet component, a wearable computer, or other suitable devices. The offsite user devices 120 may be configured to receive and/or transmit information (e.g., monitoring functionality) from and/or to the drilling rig 102 via communication with the rig computing resource environment 105. In some embodiments, the offsite user devices 120 may provide control processes for controlling operation of the various systems of the drilling rig 102. In some embodiments, the offsite user devices 120 may communicate with the remote computing resource environment 106 via the network 108.

The user devices 118 and/or 120 may be examples of a human-machine interface. These devices 118, 120 may allow feedback from the various rig subsystems to be displayed and allow commands to be entered by the user. In various embodiments, such human-machine interfaces may be onsite or offsite, or both.

The systems of the drilling rig 102 may include various sensors, actuators, and controllers (e.g., programmable logic controllers (PLCs)), which may provide feedback for use in the rig computing resource environment 105. For example, the downhole system 110 may include sensors 122, actuators 124, and controllers 126. The fluid system 112 may include sensors 128, actuators 130, and controllers 132. Additionally, the central system 114 may include sensors 134, actuators 136, and controllers 138. The sensors 122, 128, and 134 may include any suitable sensors for operation of the drilling rig 102. In some embodiments, the sensors 122, 128, and 134 may include a camera, a pressure sensor, a temperature sensor, a flow rate sensor, a vibration sensor, a current sensor, a voltage sensor, a resistance sensor, a gesture detection sensor or device, a voice actuated or recognition device or sensor, or other suitable sensors.

The sensors described above may provide sensor data feedback to the rig computing resource environment 105 (e.g., to the coordinated control device 104). For example, downhole system sensors 122 may provide sensor data 140, the fluid system sensors 128 may provide sensor data 142, and the central system sensors 134 may provide sensor data 144. The sensor data 140, 142, and 144 may include, for example, equipment operation status (e.g., on or off, up or down, set or release, etc.), drilling parameters (e.g., depth, hook load, torque, etc.), auxiliary parameters (e.g., vibration data of a pump) and other suitable data. In some embodiments, the acquired sensor data may include or be associated with a timestamp (e.g., a date, time or both) indicating when the sensor data was acquired. Further, the sensor data may be aligned with a depth or other drilling parameter.

Acquiring the sensor data into the coordinated control device 104 may facilitate measurement of the same physical properties at different locations of the drilling rig 102. In some embodiments, measurement of the same physical properties may be used for measurement redundancy to enable continued operation of the well. In yet another embodiment, measurements of the same physical properties at different locations may be used for detecting equipment conditions among different physical locations. In yet another embodiment, measurements of the same physical properties using different sensors may provide information about the relative quality of each measurement, resulting in a “higher” quality measurement being used for rig control, and process applications. The variation in measurements at different locations over time may be used to determine equipment performance, system performance, scheduled maintenance due dates, and the like. Furthermore, aggregating sensor data from each subsystem into a centralized environment may enhance drilling process and efficiency. For example, slip status (e.g., in or out) may be acquired from the sensors and provided to the rig computing resource environment 105, which may be used to define a rig state for automated control. In another example, acquisition of fluid samples may be measured by a sensor and related with bit depth and time measured by other sensors. Acquisition of data from a camera sensor may facilitate detection of arrival and/or installation of materials or equipment in the drilling rig 102. The time of arrival and/or installation of materials or equipment may be used to evaluate degradation of a material, scheduled maintenance of equipment, and other evaluations.

The coordinated control device 104 may facilitate control of individual systems (e.g., the central system 114, the downhole system, or fluid system 112, etc.) at the level of each individual system. For example, in the fluid system 112, sensor data 128 may be fed into the controller 132, which may respond to control the actuators 130. However, for control operations that involve multiple systems, the control may be coordinated through the coordinated control device 104. Examples of such coordinated control operations include the control of downhole pressure during tripping. The downhole pressure may be affected by both the fluid system 112 (e.g., pump rate and choke position) and the central system 114 (e.g. tripping speed). When it is desired to maintain certain downhole pressure during tripping, the coordinated control device 104 may be used to direct the appropriate control commands. Furthermore, for mode based controllers which employ complex computation to reach a control setpoint, which are typically not implemented in the subsystem PLC controllers due to complexity and high computing power demands, the coordinated control device 104 may provide the adequate computing environment for implementing these controllers.

In some embodiments, control of the various systems of the drilling rig 102 may be provided via a multi-tier (e.g., three-tier) control system that includes a first tier of the controllers 126, 132, and 138, a second tier of the coordinated control device 104, and a third tier of the supervisory control system 107. The first tier of the controllers may be responsible for safety critical control operation, or fast loop feedback control. The second tier of the controllers may be responsible for coordinated controls of multiple equipment or subsystems, and/or responsible for complex model based controllers. The third tier of the controllers may be responsible for high level task planning, such as to command the rig system to maintain certain bottom hole pressure. In other embodiments, coordinated control may be provided by one or more controllers of one or more of the drilling rig systems 110, 112, and 114 without the use of a coordinated control device 104. In such embodiments, the rig computing resource environment 105 may provide control processes directly to these controllers for coordinated control. For example, in some embodiments, the controllers 126 and the controllers 132 may be used for coordinated control of multiple systems of the drilling rig 102.

The sensor data 140, 142, and 144 may be received by the coordinated control device 104 and used for control of the drilling rig 102 and the drilling rig systems 110, 112, and 114. In some embodiments, the sensor data 140, 142, and 144 may be encrypted to produce encrypted sensor data 146. For example, in some embodiments, the rig computing resource environment 105 may encrypt sensor data from different types of sensors and systems to produce a set of encrypted sensor data 146. Thus, the encrypted sensor data 146 may not be viewable by unauthorized user devices (either offsite or onsite user device) if such devices gain access to one or more networks of the drilling rig 102. The sensor data 140, 142, 144 may include a timestamp and an aligned drilling parameter (e.g., depth) as discussed above. The encrypted sensor data 146 may be sent to the remote computing resource environment 106 via the network 108 and stored as encrypted sensor data 148.

The rig computing resource environment 105 may provide the encrypted sensor data 148 available for viewing and processing offsite, such as via offsite user devices 120. Access to the encrypted sensor data 148 may be restricted via access control implemented in the rig computing resource environment 105. In some embodiments, the encrypted sensor data 148 may be provided in real-time to offsite user devices 120 such that offsite personnel may view real-time status of the drilling rig 102 and provide feedback based on the real-time sensor data. For example, different portions of the encrypted sensor data 146 may be sent to offsite user devices 120. In some embodiments, encrypted sensor data may be decrypted by the rig computing resource environment 105 before transmission or decrypted on an offsite user device after encrypted sensor data is received.

The offsite user device 120 may include a client (e.g., a thin client) configured to display data received from the rig computing resource environment 105 and/or the remote computing resource environment 106. For example, multiple types of thin clients (e.g., devices with display capability and minimal processing capability) may be used for certain functions or for viewing various sensor data.

The rig computing resource environment 105 may include various computing resources used for monitoring and controlling operations such as one or more computers having a processor and a memory. For example, the coordinated control device 104 may include a computer having a processor and memory for processing sensor data, storing sensor data, and issuing control commands responsive to sensor data. As noted above, the coordinated control device 104 may control various operations of the various systems of the drilling rig 102 via analysis of sensor data from one or more drilling rig systems (e.g. 110, 112, 114) to enable coordinated control between each system of the drilling rig 102. The coordinated control device 104 may execute control commands 150 for control of the various systems of the drilling rig 102 (e.g., drilling rig systems 110, 112, 114). The coordinated control device 104 may send control data determined by the execution of the control commands 150 to one or more systems of the drilling rig 102. For example, control data 152 may be sent to the downhole system 110, control data 154 may be sent to the fluid system 112, and control data 154 may be sent to the central system 114. The control data may include, for example, operator commands (e.g., turn on or off a pump, switch on or off a valve, update a physical property setpoint, etc.). In some embodiments, the coordinated control device 104 may include a fast control loop that directly obtains sensor data 140, 142, and 144 and executes, for example, a control algorithm. In some embodiments, the coordinated control device 104 may include a slow control loop that obtains data via the rig computing resource environment 105 to generate control commands.

In some embodiments, the coordinated control device 104 may intermediate between the supervisory control system 107 and the controllers 126, 132, and 138 of the systems 110, 112, and 114. For example, in such embodiments, a supervisory control system 107 may be used to control systems of the drilling rig 102. The supervisory control system 107 may include, for example, devices for entering control commands to perform operations of systems of the drilling rig 102. In some embodiments, the coordinated control device 104 may receive commands from the supervisory control system 107, process the commands according to a rule (e.g., an algorithm based upon the laws of physics for drilling operations), and/or control processes received from the rig computing resource environment 105, and provides control data to one or more systems of the drilling rig 102. In some embodiments, the supervisory control system 107 may be provided by and/or controlled by a third party. In such embodiments, the coordinated control device 104 may coordinate control between discrete supervisory control systems and the systems 110, 112, and 114 while using control commands that may be optimized from the sensor data received from the systems 110 112, and 114 and analyzed via the rig computing resource environment 105.

The rig computing resource environment 105 may include a monitoring process 141 that may use sensor data to determine information about the drilling rig 102. For example, in some embodiments the monitoring process 141 may determine a drilling state, equipment health, system health, a maintenance schedule, or any combination thereof. Furthermore, the monitoring process 141 may monitor sensor data and determine the quality of one or a plurality of sensor data. In some embodiments, the rig computing resource environment 105 may include control processes 143 that may use the sensor data 146 to optimize drilling operations, such as, for example, the control of drilling equipment to improve drilling efficiency, equipment reliability, and the like. For example, in some embodiments the acquired sensor data may be used to derive a noise cancellation scheme to improve electromagnetic and mud pulse telemetry signal processing. The control processes 143 may be implemented via, for example, a control algorithm, a computer program, firmware, or other suitable hardware and/or software. In some embodiments, the remote computing resource environment 106 may include a control process 145 that may be provided to the rig computing resource environment 105.

The rig computing resource environment 105 may include various computing resources, such as, for example, a single computer or multiple computers. In some embodiments, the rig computing resource environment 105 may include a virtual computer system and a virtual database or other virtual structure for collected data. The virtual computer system and virtual database may include one or more resource interfaces (e.g., web interfaces) that enable the submission of application programming interface (API) calls to the various resources through a request. In addition, each of the resources may include one or more resource interfaces that enable the resources to access each other (e.g., to enable a virtual computer system of the computing resource environment to store data in or retrieve data from the database or other structure for collected data).

The virtual computer system may include a collection of computing resources configured to instantiate virtual machine instances. The virtual computing system and/or computers may provide a human-machine interface through which a user may interface with the virtual computer system via the offsite user device or, in some embodiments, the onsite user device. In some embodiments, other computer systems or computer system services may be utilized in the rig computing resource environment 105, such as a computer system or computer system service that provisions computing resources on dedicated or shared computers/servers and/or other physical devices. In some embodiments, the rig computing resource environment 105 may include a single server (in a discrete hardware component or as a virtual server) or multiple servers (e.g., web servers, application servers, or other servers). The servers may be, for example, computers arranged in any physical and/or virtual configuration

In some embodiments, the rig computing resource environment 105 may include a database that may be a collection of computing resources that run one or more data collections. Such data collections may be operated and managed by utilizing API calls. The data collections, such as sensor data, may be made available to other resources in the rig computing resource environment or to user devices (e.g., onsite user device 118 and/or offsite user device 120) accessing the rig computing resource environment 105. In some embodiments, the remote computing resource environment 106 may include similar computing resources to those described above, such as a single computer or multiple computers (in discrete hardware components or virtual computer systems).

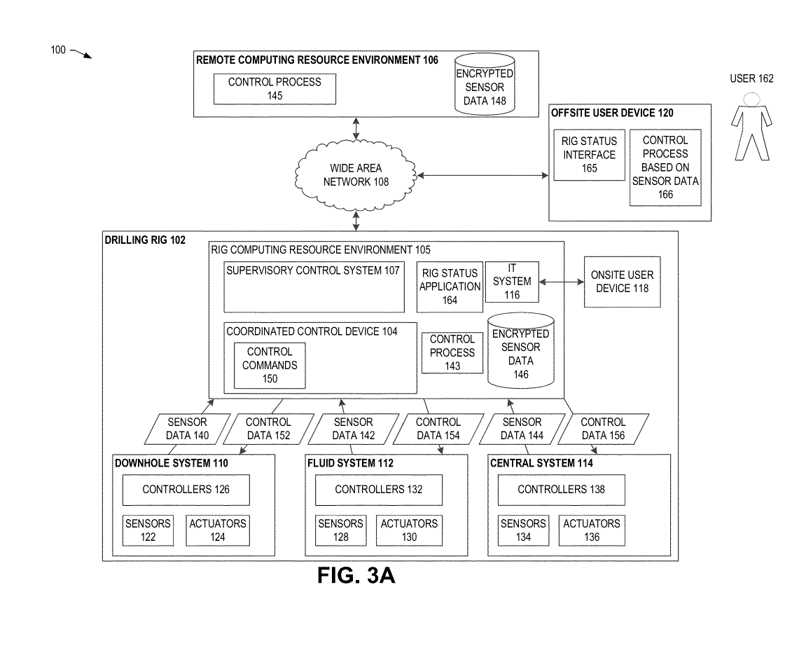

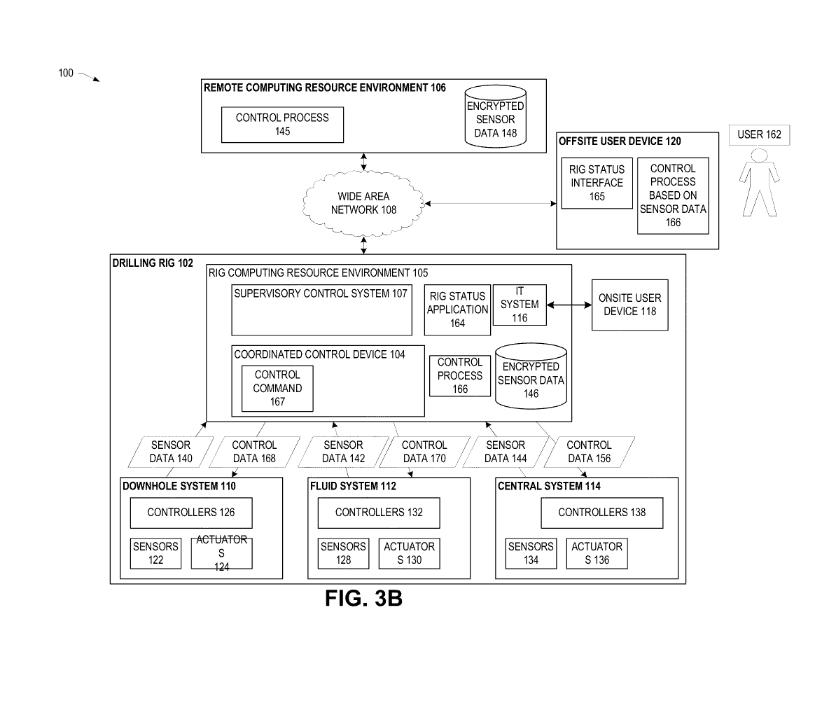

In some embodiments, a control process for the drilling rig 102 may be determined offsite and provided to the drilling rig 102 via the unified control system 100. FIGS. 3A and 3B depict an example control process for the drilling rig 102 via the unified control system 100 in accordance with an embodiment of the disclosure. Moreover, although FIGS. 3A and 3B are described with reference to example control processes, the techniques illustrated in the figures and described herein are also applicable to other suitable control processes.

As shown in FIGS. 3A and 3B, a user 162 may access, via the offsite user device, encrypted sensor data 148 stored on the rig computing resource environment. For example, the rig computing resource environment 105 may provide access to a rig status application 164 accessible via a rig status interface 165 provided on the offsite user device 120. Upon analyzing the encrypted sensor data, a control process 166 may be determined at an offsite location. The control process 166 may be sent to the rig computing resource environment 105 via the wide area network 108 and used to control one or more systems of the drilling rig 102, such as via commands provided from the coordinated control device 104.

As shown in FIG. 3B, the rig computing resource environment 105 may receive the control process 166. In some embodiments, the control process 166 may be a supervisory control process used by the supervisory control system 107. The control process 166 may be sent to the rig computing resource environment via a network (e.g., a wide area network 108). After receiving the control process 166, the rig computing resource environment 105, may, via the coordinated control device 104 for example, issue a control command 167 to control one or more systems of the drilling rig 102. For example, as shown in FIG. 3B, control data 168 may be sent to the downhole system 110 and control data 170 may be sent to the fluid system 112. In some embodiments, as noted above, the control process 166 may be provided via the supervisory control system 107.

The coordinated control device 104 may also include an event detector, or drilling state analyzer. The event detector or drilling state analyzer may determine the state of the drilling (such as drilling, tripping, etc.), and/or the events of the drilling process (such as kick, loss, etc.) based on the sensor data collected from the various systems. This may be employed to inform automated decision-making, e.g., using the coordinated control device 104 and/or user-based decision-making via the user devices 118, 120.

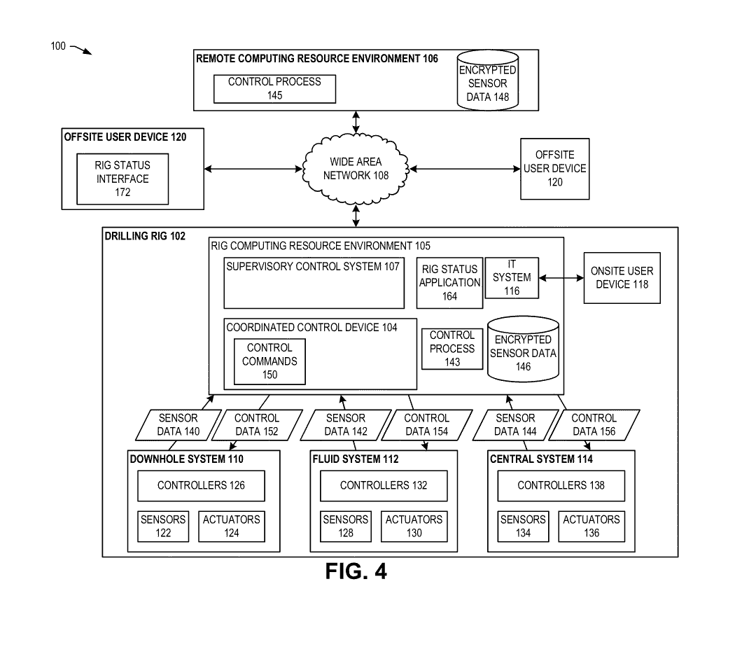

In some embodiments, additional user devices, such as offsite user devices that have proper security credentials, may be able to access data from the drilling rig 102 via the rig computing resource environment 105. FIG. 4 depicts an example of the addition of another example offsite user device 120 to the system 100 in accordance with an embodiment of the disclosure. The offsite user device 120 may access some or all of the encrypted sensor data 148 using a rig status interface 172 to access the rig status application 164 described above.

In some embodiments, the rig computing resource environment 105 may include one or more firewalls, authentication servers, or other devices that provision access to the offsite user device 120. For example, different levels of access to different types of sensor data may be provided to offsite user devices (e.g., by way of user accounts associated with a user of an offsite user device, a token provided by the offsite user device, or other suitable authentication techniques or combination thereof). In some embodiments, a user may be provided access to sensor data from a particular system of the drilling rig 102 and may be denied access to sensor data from other system of the drilling rig 102. For example, a user may be associated with a particular system, such as the downhole system 110, of the drilling rig 102. In such embodiments, a user may use the offsite user device 120 to access sensor data 140 received from the downhole system 110 and stored in the rig computing resource environment 105 (or, in some embodiments, the remote computing resource environment 106). In such embodiments, the user 162 may be unable to access sensor data provided from the other systems 112, 114, and 116 of the drilling rig 102.

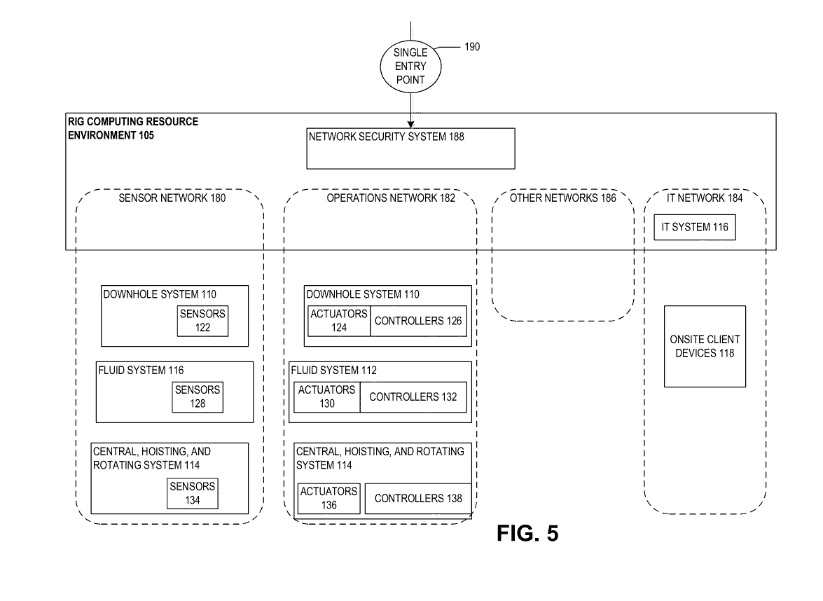

The aforementioned components of the system 100, such as sensors, actuators, and controllers, may be segregated into different communication networks (e.g., via a firewall), such that components in one network may be unable to access components and/or data on another network unless explicitly authorized by a user (e.g., an administrator) of the system 100. FIG. 5 depicts an example of various example networks of the system 100 in accordance with an embodiment of the disclosure. FIG. 5 depicts the rig computing resource environment 105 in communication with the systems of the drilling rig 102, such as the downhole system 110, the fluid system 112, the central system 114, and the IT system 116 via various different communication networks.

In some embodiments, various components of the drilling rig systems and/or the systems themselves may be segregated on different communication networks. For example, as shown in FIG. 5, the sensors 122 of the downhole system 110, the sensors 128 of the fluid system 116, and the sensors 134 of the central system 114 may communicate using a sensor network 180. The controllers 126 and actuators 124 of the downhole system 110, the controllers 132 and actuators 130 of the fluid system 132, and the controllers 138 and actuators 136 of the central system 114 may communicate using an operations network 182. The operations network 182 may also be used for communication of automation data, process control data, and other data.

Devices using the IT system 116, such as the onsite client devices 118, may communicate using an IT network 184. Finally, other networks 184 may be used in the system 100. In some embodiments, other networks 184 may include a guest network having limited access to a restricted set of networks, and may be used for guests onsite at the drilling rig 102. In some embodiments, other networks 184 may include a company-specific local area network (LAN) for employees of a company having operations at the drilling rig 102.

Each of the example networks 180, 182, 184, and 186 may be implemented using any suitable network and networking technology. Additionally, the networks 180, 182, 184, and 186 may include a wired network, a wireless network, or both. Moreover, it should be appreciated that, in some embodiments, components of the drilling rig 102 may communicate over different networks separately and simultaneously.

Each of the example networks 180, 182, 184, and 186 depicted in FIG. 5 may be segregated from one another (e.g., via a firewall). The rig computing resource environment 105 may receive and send data over each of the networks 180, 182, 184, and 186. For example, as described above, the rig computing resource environment 105 may receive data from the sensors 122, 128, and 134 via the sensor network 180. In another example, the rig computing resource environment 105 may send commands to the different systems 110, 112, and 114 via the operations network 182. In some embodiments, for example, the rig computing resource environment may provide access to data (e.g., via a rig status application) to the onsite user devices 118 via the IT network 184. In some embodiments, the rig computing resource environment 105 may monitor and control the networks 180, 182, 184, and 186.

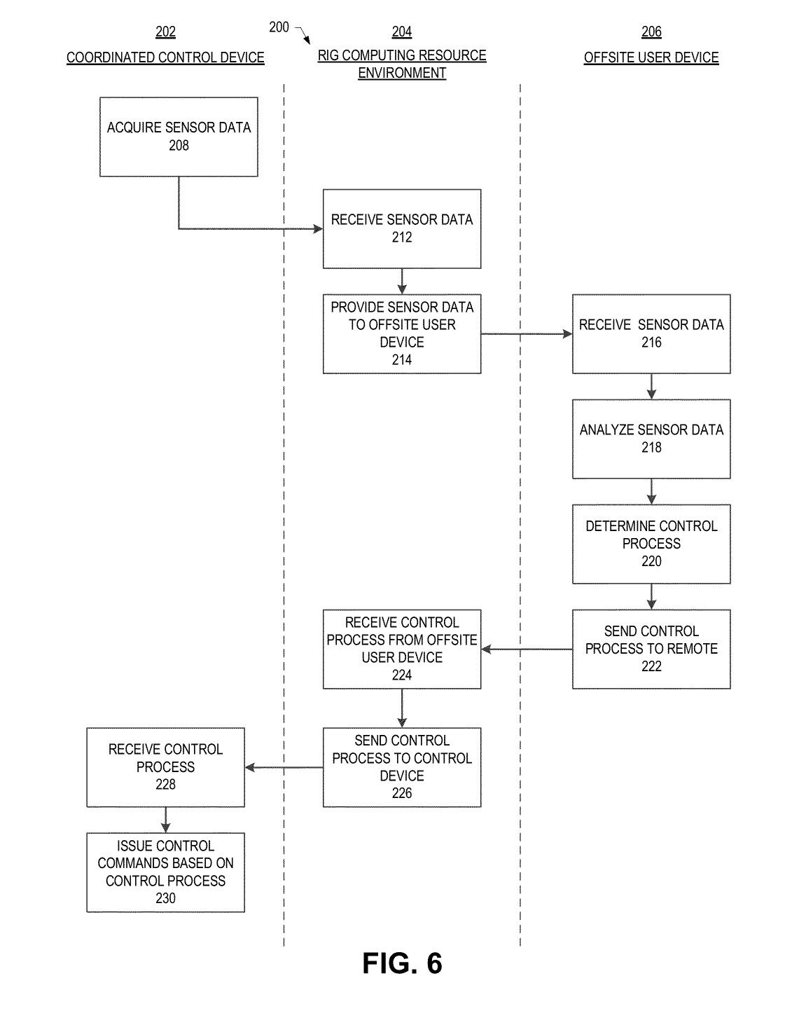

In some embodiments, as shown in FIG. 5, the rig computing resource environment 105 may include a network security system 188. In other embodiments, the network security system 188 may be distinct from the rig computing resource environment 105. The network security system 188 may provide for a single entry point 190 for devices (e.g., onsite user devices, offsite user devices, etc.) to access data and applications provided by the rig computing resource environment 105. Thus, in such embodiments, the networks 180, 182, 184, and 186, and systems and components of the drilling rig 102, may only be accessed via connection through the single entry point 190. In some embodiments, the network security system 188 may, depending on particular access levels, provide for access to the networks 180, 182, 184, and 186 of the drilling rig 102. The network security system 188 may provide user authentication, user device authentication, and other authentications to determine and provide different levels of access to different users or user devices. For example, if an offsite user device connects to the rig computing resource environment 105 via the single entry point 190, the offsite user device may have access to the IT network 184, but may be restricted from accessing the sensor network 180 and communicating directly with the sensors 122, 128, and 134. However, depending on a level of access, the offsite user device may be able to access sensor data via an application provided by the rig computing resource environment 105. In another example, depending on its access level, a user device may issue control commands to one or more of the controllers 126, 132, and 138 via the rig computing resource environment 105. FIG. 6 depicts an example control process 200 for using the unified control system 100 in accordance with an embodiment of the disclosure. FIG. 6 depicts a first column 202 corresponding to the coordinated control device 104 of the rig computing resource environment 105, a second column 204 corresponding to the rig computing resource environment 105, and a third column 206 corresponding to an offsite user device. Sensor data may be acquired by the coordinated control device (block 208), such as from various sensors of different systems of the drilling rig 102. For example, in some embodiments sensor data may be provided via a sensor network, such as that illustrated in FIG. 5 and described above. Acquired sensor data may be received by the rig computing resource environment device (block 212). For example, in some embodiments, sensor data may be transmitted over a sensor network (e.g., in real time) to the rig computing resource environment. As noted above, in some embodiments, the received sensor data may be time stamped and aligned with one or more drilling parameters (e.g., depth) before being encrypted by the rig computing resource environment 105.

The sensor data at the rig computing resource environment may be provided to offsite user devices (block 214). For example, in some embodiments, the sensor data may be transmitted over a wide area network (e.g., the Internet) in response to a request from an offsite user device that has an appropriate level of access determined by a network security system of the rig computing resource environment. In some embodiments, the sensor data may be provided via an application executed server-side on the rig control and monitoring device, client-side on the offsite user device, or a distributed application having both server-side and client-side components. The sensor data sent by the rig computing resource environment may be received at the offsite user device (block 216). In some embodiments, the sensor data may be analyzed via the offsite user device (block 218). In some embodiments, analysis may be performed using processing capabilities of the offsite user device. In some embodiments, analysis of sensor data may be performed via other devices in communication with the offsite user device.

After analysis of the sensor data, a control process (e.g., a new or modified control process) may be determined (block 220). In some embodiments, a control process may include new or modified control commands for components of systems of the drilling rig 102. The control process may be sent to the rig computing resource environment 106 (block 222) via a network (e.g., a wide area network such as the Internet). The control process may be received at the rig computing resource environment 105 (block 224). In some embodiments, additional processing, such as decoding, decrypting, or other processes may be performed on the control process. Next, a control process may be sent to the coordinated control device (block 226). In some embodiments, for example, a control process suitable for one or more systems of the drilling rig may be determined by the rig computing resource environment from a received control process. In some embodiments, a control process received at the rig computing resource environment 105 may be a supervisory control process.

A control process may be received by the coordinated control device (block 228). Using the control process, the coordinated control device may issue control commands to components of systems of the drilling rig (block 230). In this manner, sensor data acquired at a drilling rig may be sent real-time to offsite user devices for analysis and determination of control processes.

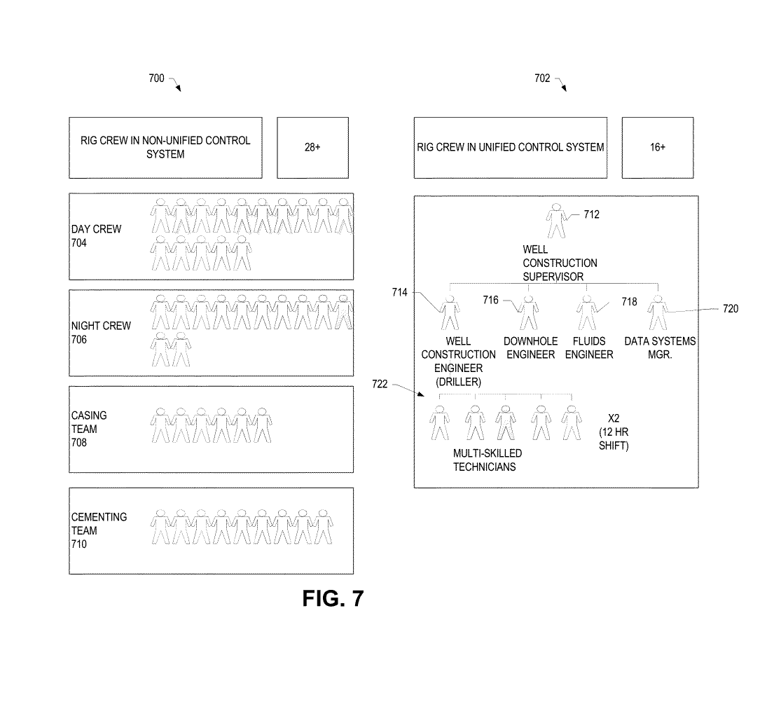

FIG. 7 is a diagram illustrating an example rig crew for a non-unified control system and an example rig crew for a unified control system (e.g., unified control system 100) described herein. The left column 700 of FIG. 7 depicts a rig crew for non-unified control systems and the right side 702 of FIG. 7 depicts a rig crew for a unified control system. As shown in FIG. 7, the rig crew for the non-unified control system may include 28 or greater persons. In such instances, for example, a day crew 704 may include 15 or more persons, a night crew 706 may include 12 or more persons, a casing team 708 may include 6 or more persons, and a cementing team 710 may include 9 or more persons.

In contrast to non-unified control systems, a rig crew for the unified control system described herein may include fewer personnel. For example, as shown in FIG. 7, in some embodiments a rig crew for the unified control system may include 16 or more person. The rig crew for the unified control system may oversee multiple systems, e.g., the systems 110, 112, and 114, using the unified control system without having distinct teams for each system or for operations carried out using each system.

As shown in FIG. 7, the rig crew for the unified control system may include, for example, a well construction supervisor 712, a well construction engineer 714 (also referred to as a “driller”), a downhole engineer 716, a fluids engineer 718, a data systems manager 720, and a number of multi-skilled technicians 722 that may work in two 12-hour shifts. Additionally, the rig crew for the unified control system may be used in a hierarchical arrangement to further reduce the number of crew and supervisory personnel. For example, as shown in FIG. 7, the well construction engineer 714, the downhole engineer 716, the fluids engineer 718, and the data systems manager 720 may be under the supervision of the well construction supervisor 712. The multi-skilled technicians 722 may be under the supervision of the well construction engineer 714.

Accordingly, it will be appreciated that the unified control system 100 disclosed herein, in at least some embodiments, may provide for enhanced workflows, which may allow for a reduced headcount on the rig. For example, operation of well construction in various phases may be performed using uniform or general rig crew, e.g., rather than highly specialized crews for each subsystem (e.g., fluid crew, managed pressure drilling crew, cementing crew, casing crew, etc.). Further, embodiments of the present disclosure may facilitate delegating the operation of rig subsystem control, maintenance, etc. to different personnel on the rig, e.g., by including role-based data provision to the user devices 118, 120, among other things. Furthermore, e.g., through the use of the remote computing environment, the system 100 may facilitate controlling or monitoring the operation of the rig and/or different subsystems from one or a plurality of unified human-machine interfaces, e.g., with proper user credentials that may be enforced by the control device 104.

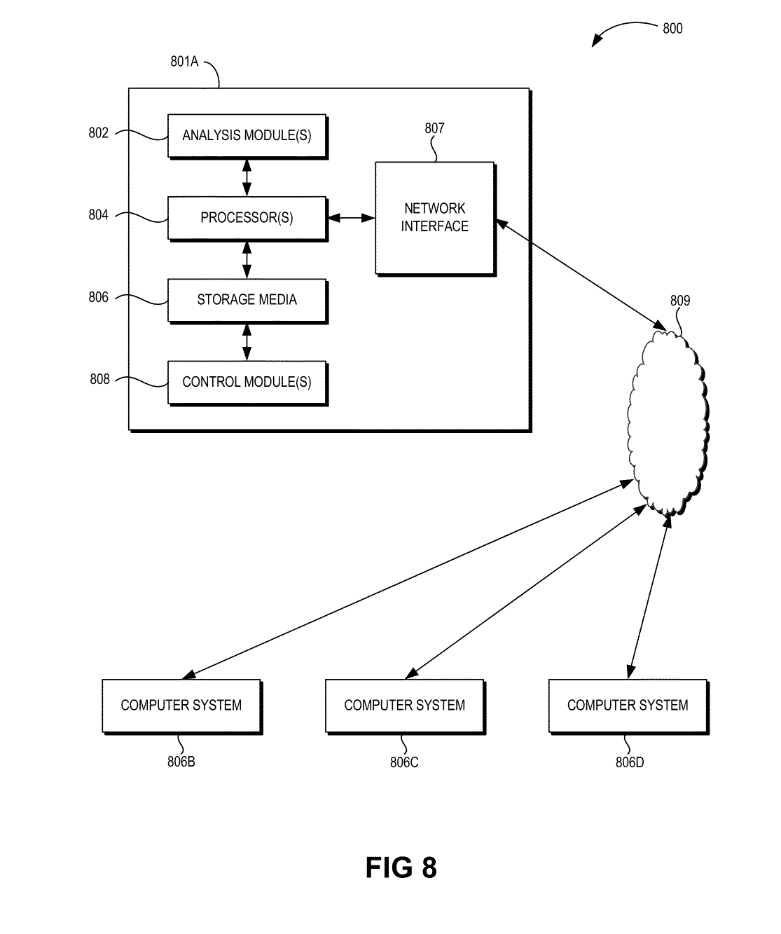

In some embodiments, the methods of the present disclosure may be executed by a computing system. FIG. 8 illustrates an example of such a computing system 800, in accordance with some embodiments. The computing system 800 may include a computer or computer system 801A, which may be an individual computer system 801A or an arrangement of distributed computer systems. The computer system 801A includes one or more analysis modules 802 that are configured to perform various tasks according to some embodiments, such as one or more methods disclosed herein. To perform these various tasks, the analysis module 802 executes independently, or in coordination with, one or more processors 804, which is (or are) connected to one or more storage media 806. The processor(s) 804 is (or are) also connected to a network interface 807 to allow the computer system 801A to communicate over a data network 809 with one or more additional computer systems and/or computing systems, such as 801B, 801C, and/or 801D (note that computer systems 801B, 801C and/or 801D may or may not share the same architecture as computer system 801A, and may be located in different physical locations, e.g., computer systems 801A and 801B may be located in a processing facility, while in communication with one or more computer systems such as 801C and/or 801D that are located in one or more data centers, and/or located in varying countries on different continents).

A processor may include a microprocessor, microcontroller, processor module or subsystem, programmable integrated circuit, programmable gate array, or another control or computing device.

The storage media 806 may be implemented as one or more computer-readable or machine-readable storage media. Note that while in the example embodiment of FIG. 6 storage media 806 is depicted as within computer system 801A, in some embodiments, storage media 806 may be distributed within and/or across multiple internal and/or external enclosures of computing system 801A and/or additional computing systems. Storage media 806 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY® disks, or other types of optical storage, or other types of storage devices. Note that the instructions discussed above may be provided on one computer-readable or machine-readable storage medium, or alternatively, may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, the computing system 800 contains one or more rig control module(s) 808. In the example of computing system 800, computer system 801A includes the rig control module 808. In some embodiments, a single rig control module may be used to perform some or all aspects of one or more embodiments of the methods disclosed herein. In alternate embodiments, a plurality of rig control modules may be used to perform some or all aspects of methods herein.

It should be appreciated that computing system 800 is only one example of a computing system, and that computing system 800 may have more or fewer components than shown, may combine additional components not depicted in the example embodiment of FIG. 8, and/or computing system 800 may have a different configuration or arrangement of the components depicted in FIG. 8. The various components shown in FIG. 8 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way used for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense and not for purposes of limitation.

What is claimed is:

1. A method for a drilling rig, comprising:
receiving, at a rig controller, data from a plurality of rig subsystems;
determining, at the rig controller, a first command based at least partially on the data from the plurality of rig subsystems, wherein the first command is related to an operating parameter of a first device of a first one of the plurality of rig subsystems; and
transmitting the first command to a first subsystem controller of the first one of the plurality of rig subsystems, wherein the first subsystem controller is configured to control the first device and implement the command.

2. The method of claim 1, wherein the plurality of rig subsystems comprises a downhole subsystem and a central subsystem.

3. The method of claim 1, further comprising transmitting at least some of the data from the plurality of rig subsystems to a human-machine interface.

4. The method of claim 3, further comprising:
determining a role of a user of the human-machine interface;
determining a subset of the data from at least one of the plurality of rig subsystems based on the role of the user; and
transmitting the subset of the data to the human-machine interface.

5. The method of claim 3, further comprising receiving, at the rig controller, a user command from the human-machine interface, wherein determining the first command is at least partially based on the user command.

6. The method of claim 1, further comprising:
receiving, at the rig controller, a command from a human-machine interface; and
transmitting, from the rig controller to a plurality of subsystem controllers of the plurality of rig subsystems, the command from the human-machine interface.

7. The method of claim 1, determining a role of a user of a human-machine-interface, wherein the role of the user is associated with two or more of the plurality rig subsystems.

8. The method of claim 1, wherein receiving the data from at least one of the plurality of rig subsystems comprises receiving sensor data collected by one or more sensors of the plurality of rig subsystems.

9. The method of claim 1, further comprising:
determining a second command based on the data received from at least one of the plurality of rig subsystems, wherein the second command is related to an operating parameter of a second device of a second one of the plurality of rig subsystems, wherein the first and second commands are coordinated; and
transmitting the second command to a second subsystem controller of the second one of the plurality of rig subsystems, wherein the second subsystem controller is configured to control the second device to implement the second command.

10. A method for a drilling rig, comprising:
receiving, at a control system, sensor data from a plurality of subsystems, each of the plurality of subsystems comprising a subsystem controller;
determining, at the control system, a command for a device of the drilling rig based on the sensor data from at least two of the plurality of subsystems, wherein the device is controlled by the subsystem controller of one of the plurality of subsystems; and
transmitting data representing the command to the subsystem controller of the one of the plurality of subsystems, wherein the data is configured to cause the subsystem controller of the one of the plurality of subsystems to implement the parameter adjustment.

11. The method of claim 10, further comprising applying timestamps to the sensor data from the plurality of subsystems, wherein the timestamp is provided by a master clock.

12. The method of claim 11, further comprising storing the sensor data in association with the timestamps.

13. The method of claim 12, further comprising:
determining a depth measurement corresponding to when the sensor data was collected or received; and
storing the sensor data in association with the depth measurement.

14. The method of claim 10, further comprising:
receiving a second command at the control system from a human-machine interface; and
determining a plurality of adjustments to a plurality of devices, respectively, of at least two of the plurality of subsystems, based on the command.

15. The method of claim 14, wherein the control system is a control system that is local to the drilling rig, the method further comprising transmitting at least some of the sensor data from the control system to a remote control system, wherein the command is received from the remote control system.

16. The method of claim 10, wherein the plurality of subsystems comprises at least one of a central subsystem, a downhole subsystem, or a fluid subsystem.

17. The method of claim 10, wherein the plurality of subsystems comprises at least one of:
a central subsystem comprising a drawworks;
a downhole subsystem comprising a bottomhole assembly; or
a fluid subsystem comprising a drilling mud pump.

18. The method of claim 10, further comprising:
encrypting the sensor data using a rig computing resource; and
storing the encrypted sensor data such that access to the sensor data is controlled by the control system.

19. The method of claim 10, further comprising:
analyzing the sensor data using a control device; and
transmitting a result of the analysis to a remote device configured to provide visualization of the result, the sensor data, or both.

20. A system for a drilling rig, comprising:
a computing resource environment located at a drilling rig, the computing resource environment comprising a control device; and
a human-machine interface for receiving a first command from a user,
wherein the control device is configured to receive sensor data from a plurality of subsystems of the drilling rig and to provide control commands to a plurality of subsystems based upon the sensor data and the first command.

21. The system of claim 20, further comprising a master clock, wherein the control device is configured to associate the sensor data with a time of the master clock.

22. The system of claim 21, wherein the control device is configured to receive a depth measurement, and wherein the control device is configured to associate the depth measurement with the time of the master clock.

23. The system of claim 20, wherein the control device is a first control device, the system further comprising a second control device that is in communication with the first control device, and wherein the second control device is configured to receive commands and provide the commands to the first control device, and the first control device is configured to convert the commands into one or more parameter adjustments, and to send the one or more parameter adjustments to one or more of the plurality of subsystems.

24. The system of claim 20, further comprising a data consistency monitor, wherein the data consistency monitor is configured to determine a quality attribute of the sensor data.

25. The system of claim 20, further comprising a network security system for authenticating communication between the computing resource environment and the subsystem.
